(19) United States
(12) Patent Application Publication
(10) Pub. No.: US 2008/0012190 A1
(43) Pub. Date: Jan. 17, 2008

(54) Automated Truss Assembly System

(75) Inventor: Jerome E. Koskovich, Byron, MN (US)

Correspondence Address: SENNIGER POWERS, ONE METROPOLITAN SQUARE, 16TH FLOOR, ST LOUIS, MO, 63102, US

(73) Assignee: MITEK HOLDINGS, INC., Wilmington, DE (US)

(21) Appl. No.: 11/741,537

(22) Filed: Apr. 27, 2007

Related U.S. Application Data
(60) Provisional application No. 60/795,974, filed on Apr. 28, 2006.

(51) Int. Cl. B25B 1/20

(52) U.S. Cl. 269/42

(57) ABSTRACT

An automated truss assembly system includes a jigging table including a plurality of automatically actuatable pucks for use in positioning the truss components on the jigging table. A laser projector is positioned to project a laser image onto the jigging table for use in positioning the truss components on the jigging table.

### CROSS-REFERENCE TO RELATED APPLICATION

The present application claims priority to U.S. Provisional Patent Application No. 60/795,974, filed Apr. 28, 2006, the entirety of which is herein incorporated by reference.

### FIELD OF THE INVENTION

The present invention generally relates to an automated truss assembly system.

### BACKGROUND OF THE INVENTION

Prefabricated trusses are often used in the construction of buildings because of their strength, reliability, low cost, and ease of use. An increase in the use of more complex and varied trusses, however, has created manufacturing problems and increased production times.

Trusses are generally assembled on a jigging table. Jig systems typically have a plurality of adjustable stops, or pucks, for indicating the proper positions of the elements of a truss and for holding these elements in position until they can be permanently secured together. The pucks must be repositioned on the jig surface for each different truss. Computer programs generally calculate the position of the pucks from a reference line, such as the edge of the table. Conventionally, an operator would measure the positions of the pucks from the reference line, manually move and secure the pucks into the desired positions, place the truss elements on the table against the pucks, fasten them together, remove the completed truss, and then repeat. Due to great variation and complexity in modern truss designs, a significant amount of production time is spent resetting the positions of the pucks and there is a high likelihood of operator error. Various approaches have been developed to enhance this process.

One method that has been developed to increase production efficiency in truss assembly is laser projection. This approach projects the image of a desired truss in actual shape and size onto a work surface. The pucks are then simply moved to their corresponding locations as indicated by the laser projection. This minimizes or eliminates the measurement time needed with conventional systems and ensures accurate placement of the pucks. Known laser truss assembly systems are disclosed in U.S. Pat. No. 5,430,662 to Ahonen, U.S. Pat. No. 6,317,980 to Buck and U.S. Pat. No. 6,170,163 to Bordignon et al, which are hereby incorporated by reference. However, these types of systems do not eliminate the need to repeatedly secure and loosen the pucks for each truss design. Although effective in increasing the correctness of assembled trusses, the time it takes for an operator to manually position the pucks with their corresponding projected image is significant.

Another approach employs a system that automatically moves the pucks along the surface of the jig. Such systems are disclosed in U.S. Pat. No. 5,854,747 to Fairlie, U.S. Pat. No. 6,712,347 to Fredrickson et al, and U.S. Pat. No. 5,342,030 to Taylor, which are hereby incorporated by reference. The goal of such systems is speed and efficiency greater than prior systems such as manual jig tables and laser projection. For example, the '347 patent criticizes prior laser projection systems as being too slow and expensive. While these systems may speed up the process, they tend to suffer reliability and consistency issues. Because trusses are often made from wood, sawdust and wood chips often pile up on the jigging table. This debris can fall into the slots in which the pucks move, hampering or preventing the pucks from reaching their proper position or preventing the pucks from being properly secured. An operator assembling a truss based on faulty positioning caused by one of these problems may fail to notice when one of the pucks is not in its proper place, possibly leading to an entire batch of improperly aligned trusses. In addition, any error by the software or hardware system controlling the pucks is not likely to be caught by an operator as there is nothing to indicate that there are pucks that are not properly aligned.

### SUMMARY OF THE INVENTION

According to one aspect of the present invention, a truss assembly system for use in assembling a truss from a plurality of truss components generally comprises a jigging table including a plurality of automatically actuatable pucks for use in positioning the truss components on the jigging table. A laser projector is positioned to project a laser image onto the jigging table for use in positioning the truss components on the jigging table.

In another aspect, a method of indicating the positioning of the components of a truss on a work surface that includes a plurality of pucks moveable on the work surface and fixable to the work surface to define the relative position of the truss components generally comprises projecting a laser image of at least a portion of the components onto the work surface. A puck control system is actuated to automatically move the pucks into positions corresponding to locations of the components of the truss.

Other features will be in part apparent and in part pointed out hereinafter.

### BRIEF DESCRIPTION OF THE DRAWINGS

FIG. 1 is a perspective of a truss assembly system including a jigging table and a laser projection system;

FIG. 2 is similar to FIG. 1 showing the laser projection system projecting an outline of truss components on the jigging table; and

FIG. 3 is similar to FIG. 1 showing a truss being assembled on the jigging table.

Corresponding reference characters indicate corresponding parts throughout the drawings.

### DETAILED DESCRIPTION OF THE DRAWINGS

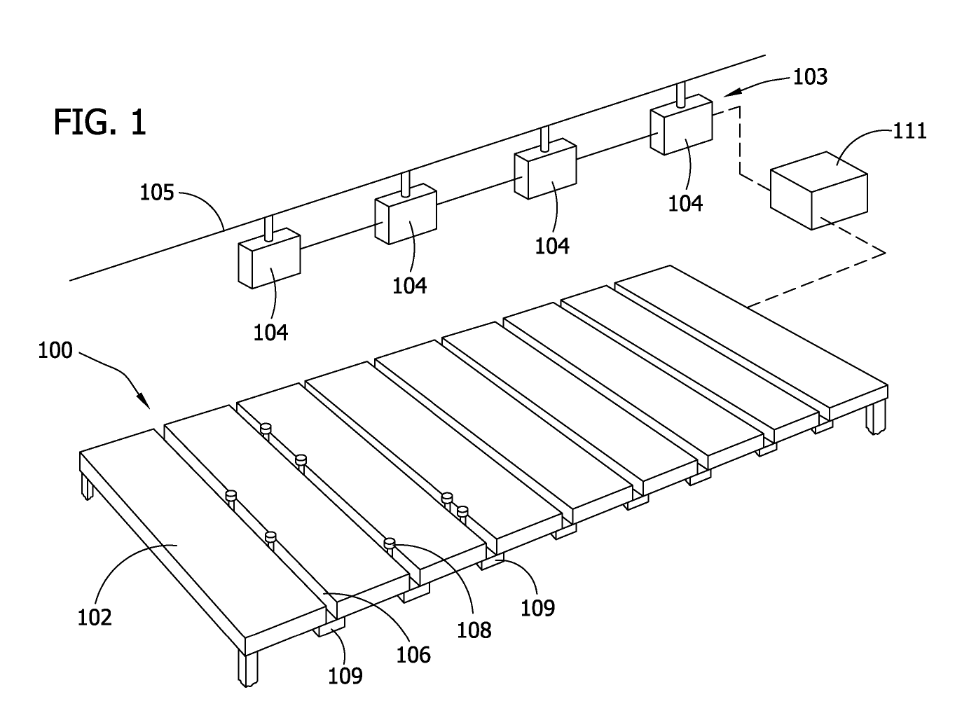

Referring to FIGS. 1-3, there can be seen a truss assembly system 100 according to an embodiment of the present invention. Truss assembly system 100 includes a jigging table 102 and a laser projection system 103 having one or more laser projectors 104. Jigging table 102 includes a plurality of slots 106 through which a plurality of pucks 108 are moveable by puck drives 109 along the slots 106 and may be slidable on the table 102. The puck drives 109 and consequently the pucks 108 are controlled by computerized system controller 111. Such automated slotted tables are known and are commercially available. An example of such an automated slotted table is described in U.S. Pat. No. 5,854,747 (owned by the assignee of the present application) and U.S. Pat. No. 6,899,324, the entireties of which are herein incorporated by reference. Although depicted as extending across the width of the table 102, slots 106 may also extend lengthwise or at an angle across the table.

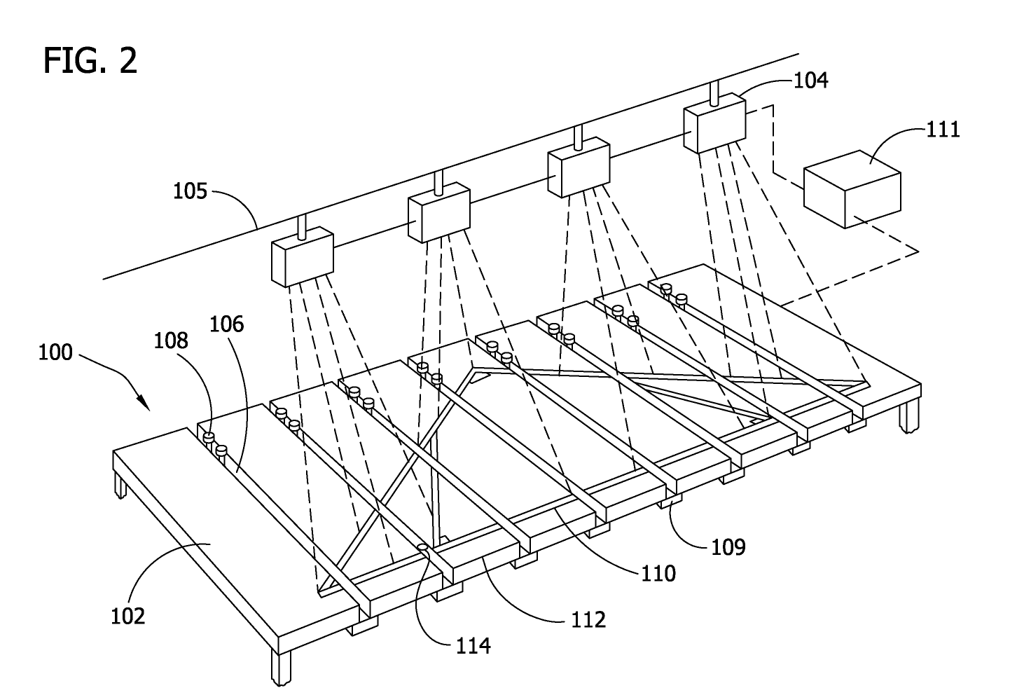

Laser projectors 104 are suspended above the table 102, for example, from the ceiling 105. As will be understood by those skilled in laser projection assembly methods, laser projection system 103 further includes a computerized system controller 111 operably connected to the laser projectors 104. A truss design can be loaded into the computer using software known in the art and communicated to the laser projectors 104. As shown in FIG. 2, the lasers 104 then project an outline 110 of the truss components to be assembled onto the table 102. Alternatively, or in addition to projecting an outline of the truss components, the laser projectors 104 may project a positioning image indicative of respective positions of one or more truss members, and/or “planks” 112, and/or the pucks 114 and/or nail plates (not shown). Moreover, the laser projectors 104 may project textual information, or indicia. An example of a laser projection system is described in U.S. Pat. No. 6,317,980 (owned by the assignee of the present application) and 6,170,163, the entireties of which are herein incorporated by reference.

As is understood by one of skill in the art, the computerized control system 111 into which the truss design is entered or stored is also operably connected to a control system which controls movement of the pucks 108 on the table 102 and the projection. Alternatively, puck control system and laser projection system may be connected to separate computer systems. Software programs are well known and generally available that can calculate the positions of the pucks on the jig table and communicate them to the puck control system. The pucks 102 are then automatically moved and secured in their predetermined positions, which should be aligned with their corresponding images produced by the laser projectors 104. The existence of the laser outline 110 allows an operator to double check the accuracy of the automatic puck control system.

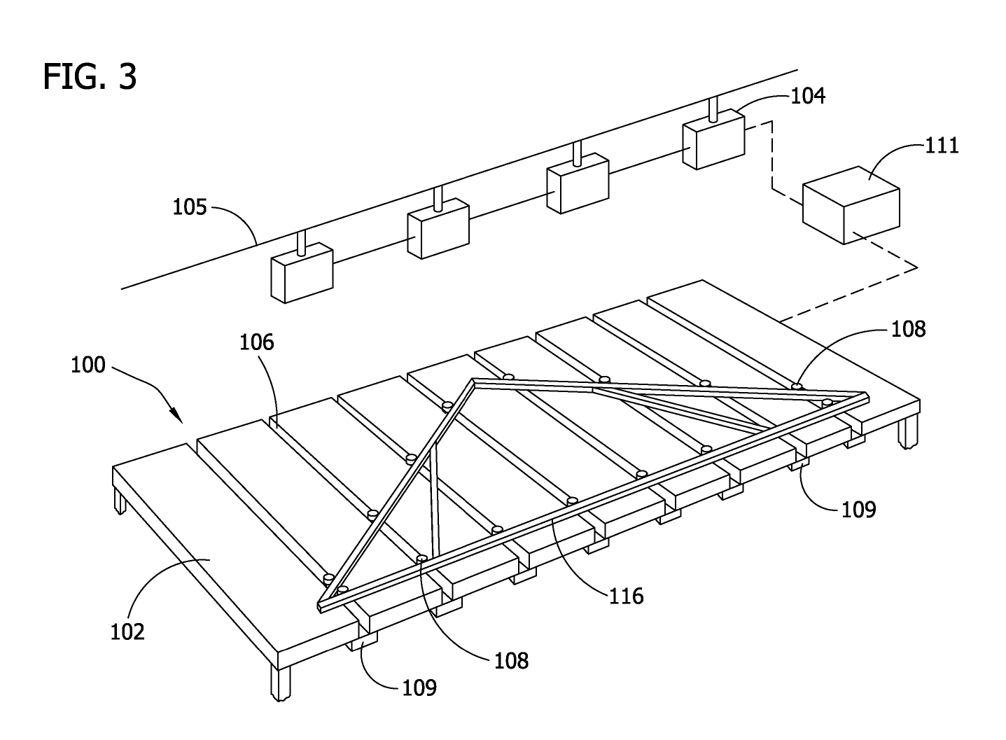

As shown in FIG. 3, an operator can now assemble the truss on the table 102 using both the puck placement and the laser image of the truss members as guides. Typically, the truss members 116 are placed on the table in the area defined by the puck locations and laser image. The truss members 116 are then interconnected by truss connector plates. Any desired number of trusses having the displayed configuration can now be assembled. The laser outline 110 ensures that an operator will notice if one or more of the pucks 108 are not in proper position or if incorrect truss components are used or if such components are not correctly positioned. Such components include the truss member as well as nail plates. Additional truss designs can be made by simply entering a new truss configuration into or retrieving a stored configuration from the computerized control system.

The combination of an automated truss assembly system with a laser projection truss assembly system is advantageous because each makes up for the deficiencies of the other. Because the main goal of a laser projection system is accuracy of truss assembly, speed is sacrificed by having an operator carefully align each puck with its corresponding image. Because the main goal of an automated truss assembly system is to set the table up as quickly and efficiently as possible, accuracy and reliability can be hampered. These problems are alleviated by the present design. Use of an automated system dramatically increases the speed and efficiency of the system relative to standard laser projections systems. Additionally, the laser projection of the present system provides a check on the automated system such that an operator can tell with a glance at the table whether it is functioning accurately and reliably.

Having described the illustrated embodiment of the invention in detail, it will be apparent that modifications and variations are possible without departing from the scope of the invention defined in the appended claims.

When introducing elements of the present invention or the illustrated embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A truss assembly system for use in assembling a truss from a plurality of truss components, the truss assembly system comprising:
a jigging table including a plurality of automatically actuatable pucks for use in positioning the truss components on the jigging table; and
a laser projector positioned to project a laser image onto the jigging table for use in positioning the truss components on the jigging table.

2. The truss assembly system as set forth in claim 1 further comprising a computer system for actuating the pucks.

3. The truss assembly system as set forth in claim 2 wherein the computer system controls the laser projector.

4. The truss assembly system as set forth in claim 1 wherein the laser image projected by the laser projector includes a truss component position indicator.

5. The truss assembly system as set forth in claim 4 wherein the truss component position indicator comprises an outline of at least one of the truss components.

6. The truss assembly system as set forth in claim 1 wherein the laser image projected by the laser projector includes a puck position indicator.

7. The truss assembly system as set forth in claim 6 wherein the laser image projected by the laser projector includes an outline of at least one of the truss components.

8. The truss assembly system as set forth in claim 1 wherein the laser image projected by the laser projector indicates a location of at least one of a nail plate for securing at least two of the truss component together.

9. A method of indicating the positioning of the components of a truss on a work surface, said work surface including a plurality of pucks moveable on said work surface and fixable to said work surface to define the relative position of said truss components, the method comprising the steps of:
projecting a laser image of at least a portion of said components onto the work surface; and
actuating a puck control system to automatically move the pucks into positions corresponding to locations of the components of the truss.

10. The method of assembling the components of a truss of claim 9, wherein projecting a laser image comprises projecting both a truss member position indicator and puck position indicator, the method further comprising comparing the locations of the plurality of pucks with the puck positions indicators.

11. The method of assembling the components of a truss of claim 9, further comprising entering a truss design into a computer system operably coupled to a laser projection system and the puck control system.

12. The method of assembling the components of a truss of claim 11, further comprising running a program on the computer system that:
projects an image of the truss design onto the work surface with the laser projection system; and
uses the puck control system to move the plurality of pucks into positions corresponding to the truss design projected onto the work surface.
